(19) United States
(12) Patent Application Publication
(10) Pub. No.: US 2008/0019873 A1
(43) Pub. Date: Jan. 24, 2008

(54) SYSTEM, APPARATUS AND METHOD FOR EVALUATING THE CONSTITUENTS OF A HEAT EXCHANGE FLUID HAVING CORROSION INHIBITORS THEREIN

(76) Inventors: Vatsal Mukundlal Shah, Sugar Land, TX (US); Robert Szentirmay, Houston, TX (US); Priestley Jing-Kong Wang, Houston, TX (US); Irina Gabrielova, Houston, TX (US)

Correspondence Address: SHELL OIL COMPANY, P O BOX 2463, HOUSTON, TX, 772522463, US

(21) Appl. No.: 11/777,066

(22) Filed: Jul. 12, 2007

Related U.S. Application Data
(60) Provisional application No. 60/831,350, filed on Jul. 17, 2006.

(51) Int. Cl. G01N 15/06

(52) U.S. Cl. 422/68.1

(57) ABSTRACT

A method, system, and apparatus are described for evaluating the constituents of a heat exchange fluid having acid-based corrosion inhibitors therein, such as organic acid-based corrosion inhibitors. The method provides for obtaining a sample of the heat exchange fluid and then acidifying the sample to reduce the solubility of target acid-based corrosion inhibitors therein. This may be done, for example by adding an acid or acid buffer to the sample. The target acid-based corrosion inhibitors are then separated from the acidified sample. For example, the acidified sample may be passed through a solid phase extraction device to separate the target acid-based corrosion inhibitors from the sample. The separated acid-based corrosion inhibitors are then evaluated, thereby obtaining an indication of the concentration of acid-based corrosion inhibitors in the subject heat exchange fluid.

### RELATED APPLICATIONS

The present application claims priority to U.S. Application Ser. No. 60/831,350, filed Jul. 17, 2006, which is incorporated herein by reference.

### FIELD OF THE INVENTION

The present invention relates generally to a system, apparatus, and method for evaluating the constituents of a heat exchange fluid having corrosion inhibitors therein.

### BACKGROUND OF THE INVENTION

The systems, apparatus, and methods described herein are particularly suited for determining the constituents of such heat exchange fluids as organic acid technology coolants. Referred to as “extended life coolants,” these heat exchange fluids typically contain carboxylate salts of long-chain alkyl-based organic acids or of aromatic-based organic acids (hereinafter “acid-based corrosion inhibitors”) as corrosion inhibitors. These corrosion inhibitors inhibit corrosion of metallic surfaces with which the heat exchange fluid comes in contact. The organic acid-based corrosion inhibitors are also formulated for longer or extended service lives as compared to inorganic acid-based corrosion inhibitors. The recommended service life for “extended life coolants” (ELC) (under normal driving conditions) is commonly about five years, whereas the recommended service life for conventional coolants may be about two years. Suitable acid-based corrosion inhibitors include carboxylate salts of long chain alkyl monocarboxylic organic acids (such as 2-ethyl hexanoic acid, octanoic acid, etc.), of dicarboxylic acids (e.g., sebacic acid), or of aromatic organic acids (such as benzoic acids and p-toluic acids).

An expanded description of the type of heat exchange fluid that is a subject of the present invention and its application are provided in U.S. Pat. No. 5,997,763 (assigned to the Assignee of the present Application) and U.S. Pat. No. 6,475,438. Such heat exchange fluid types are widely used. It is further noted that the subject heat exchange fluids may be aqueous and/or glycol compositions and used for automotive, heavy duty, marine and other industrial applications.

In any case, there is not available a reliable and convenient method or equipment for evaluating the constituents of such heat exchange fluids having corrosion inhibitors therein, so as to, for example, determine the sufficiency of the corrosion inhibitor content to provide corrosion protection. More particularly, there is not a method or equipment for evaluating the sufficiency of the amount of corrosion inhibitors in fresh (mixed for use) or used heat exchange fluids to continue to provide protection. Analytical methods exist but such methods typically require equipment, facilities and/or time that are not readily available or convenient to use (e.g., in the field). Moreover, used heat exchange fluids typically include an array of components, including interferents. These interferents can alter the accuracy of conventional analytical techniques.

### SUMMARY OF THE INVENTION

In one embodiment of the present invention, a method is provided for evaluating the constituents of a heat exchange fluid having acid-based corrosion inhibitors therein. This method comprises the following steps: acidifying the sample such that target acid-based corrosion inhibitors are rendered at least partially insoluble therein; separating the target acid-based corrosion inhibitors from the acidified sample; evaluating the separated acid-based corrosion inhibitors, thereby obtaining an indication of the concentration of acid-based corrosion inhibitors in the subject heat exchange fluid.

In another aspect of the invention, a method is provided for evaluating the constituents of a heat exchange fluid having acid- based corrosion inhibitors. This alternate method comprises the following steps: obtaining a sample of the heat exchange fluid; separating target organic acid-based corrosion inhibitors from the sample; and evaluating the separated organic acid-based corrosion inhibitors, thereby obtaining an indication of the concentration of organic acid-based corrosion inhibitors in the subject heat exchange fluid.

In yet another aspect of the invention, an apparatus is provided for evaluating the constituency of a heat exchange fluid having acid-based corrosion inhibitors therein. The inventive apparatus comprises: a bank of solution containers including a first container for receiving a sample of the heat exchange fluid and a second container for holding an acidifying solution; an extraction device for separating acid-based corrosion inhibitors from an acidified mixture of the heat exchange fluid and the acidifying solution; and a pumping system fluidly interconnected with the bank of containers and the extraction device, the pumping system being operable to selectively draw amounts of the heat exchange fluid and the acidifying sample from the first and second containers, respectively, and to pass a resultant acidified mixture through the extraction device, wherein target acid-based corrosion inhibitors are retained in the extraction device.

In yet another aspect of the invention, a system is provided for evaluating the constituency of a heat exchange fluid having acid-based corrosion inhibitors therein. The inventive system comprises: a first container for receiving a sample of the heat exchange fluid; a second container holding an acidifying solution; and an extraction device adapted to separate target acid-based corrosion inhibitors from an acidified mixture of the heat exchange fluid and the acidifying solution received from the first and second containers.

### BRIEF DESCRIPTION OF THE DRAWINGS

For a more detailed understanding of the preferred embodiments, reference is made to the accompanying Figures, wherein:

FIG. 1 is a simplified flowchart illustration of a method for evaluating the constituents of a heat exchange fluid, according to the present invention;

FIGS. 2A-2D are simplified illustrations of a method for evaluating the constituents of a heat exchange fluid, according to the present invention;

FIG. 3 is a schematic of an apparatus for evaluating the constituents of a heat exchange fluid, according to the present invention;

FIG. 3A is a front view of an apparatus corresponding to the schematic of FIG. 3;

FIG. 4 is an alternative test apparatus for evaluating the constituents of a heat exchange fluid, according to the present invention; and

FIG. 5 is an alternative apparatus for evaluating the constituents of a heat exchange fluid, according to the present invention.

### DETAILED DESCRIPTION OF THE INVENTION

The present invention provides a method, system, and apparatus for evaluating the constituents of a heat exchange fluid. The systems, apparatus, and methods described herein are particularly suited for determining the constituents of such heat exchange fluids as organic acid technology coolants. Referred to as “extended life coolants,” these heat exchange fluids typically contain carboxylate salts of long-chain alkyl-based organic acids or of aromatic-based organic acids (hereinafter “acid-based corrosion inhibitors”) as corrosion inhibitors. These corrosion inhibitors inhibit corrosion of metallic surfaces with which the heat exchange fluid comes in contact. The organic acid-based corrosion inhibitors are also formulated for longer or extended service lives as compared to inorganic acid-based corrosion inhibitors. Suitable organic acid-based corrosion inhibitors include carboxylate salts of long chain alkyl monocarboxylic organic acids (such as 2-ethyl hexanoic acid, octanoic acid, etc.), of dicarboxylic acids (e.g., sebacic acid), or of aromatic organic acids (such as benzoic acids and p-toluic acids).

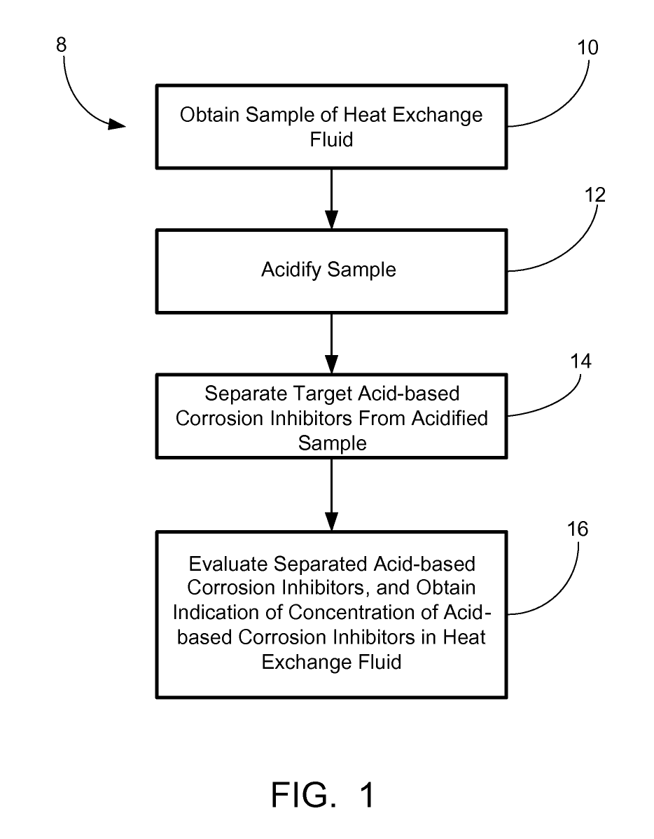

FIGS. 1-5 embody various aspects of the inventive method, system, and apparatus. With the present method, system, and apparatus, the content of acid-based corrosion inhibitors in the heat exchange fluid may be evaluated to determine the sufficiency of the content to provide corrosion protection. As further described below, the invention provides a reliable, field-usable, and convenient method for analyzing fresh and used heat exchange fluids. The invention is advantageous over prior art method and systems, in one respect, because it provides a means for the separation of target corrosion inhibitors of analytical interest from the sample (and from analytical interferents), thereby providing significantly more accurate results. This is particularly true, in respect to contaminated, spent, and weathered coolants, which typically contain large amounts of analytical interferents.

The invention also provides a method, system, and apparatus that are readily useable in the field (i.e., outside the laboratory setting) and produce reliable results. This is made possible, in part, because the invention provides for the separation of the target corrosion inhibitors from the sample (i.e., from analytical interferents). The method is also relatively simple and requires a minimal number of equipment and steps. Accordingly, it is contemplated that the invention will be particularly beneficial to OEM's, fleet owners, the automobile service industry, and every day automobile owners. The mechanic, maintenance personnel, or car owner can accurately determine the concentration or level of acid-based inhibitors present in heat exchange fluid samples or whether the concentration or level in the heat exchange fluid is above or equal to a predetermined minimum threshold. With this information, the same personnel can determine the sufficiency of the heat exchange fluid for continued use and/or determine how much, if any, of fresh coolant must be added to maintain the utility of the coolant.

Target acid-based corrosion inhibitors include organic acid-based corrosion inhibitors, and more particularly, carboxylate salts of long-chain organic acids such as alkyl monocarboxylic acids and dicarboxylic acids, and carboxylate salts of aromatic based monocarboxylic or dicarboxylic acids. As will be described below, the sufficiency of the amount of corrosion inhibitors retained in the heat exchange fluid may be evaluated qualitatively or quantitatively.

It should be noted, however, that the methods, systems and apparatus described herein are provided for exemplary purposes only. It will become apparent to one skilled in the relevant chemical, mechanical, instrumentation, or other relevant art that various aspects of the concepts described herein may be applicable to other fluid evaluating or testing methods, systems, or apparatus that deviate to some degree from those described herein. It should also become apparent that these methods, systems, and apparatus may be applicable to fluids other than the heat exchange fluids specifically described herein.

The evaluating methods described herein may be performed manually or, by using an automated system and/or apparatus. FIG. 1 provides a simplified flow chart 8 illustrating the basic steps of the evaluating method. Generally, the method involves obtaining a sample of the heat exchange fluid (step 10), preferably a predetermined amount. The pH of the sample is then adjusted (i.e., acidified using an acidifying solution, for example) so as to reduce the solubility of target acid-based corrosion inhibitors in the sample (step 12). This preferably results in the conversion of at least some (if not substantially all) of the salt form of the target acid-based corrosion inhibitors to its acid form. The acid forms of these corrosion inhibitors are known to be much less soluble in water than the salt form and are, therefore, more susceptible to phase separation as well as solid phase adsorption. The objective is to adjust the pH of the sample so as to at least render the target components susceptible to solid phase adsorption from the solution, even if a complete physical phase separation has not occurred. In most applications, this requires the target corrosion inhibitor to be rendered at least partially soluble in the sample. As further explained below, this means that the target concentration of corrosion inhibitor has reached its solubility limit in the fluid sample.

In a typical application, the target corrosion inhibitors of interest may be composed of different groups of corrosion inhibiting compounds, such as groups of carboxylate salts of organic acids. These carboxylate salts will be present at different concentrations and their acidic forms will be at different degrees of solubility in the solution. The target groups of compounds will be characterized by different pKₐ values. For each specific corrosion inhibitor acid, the exact pH at which phase separation initiates depends upon the total concentration of that specific inhibitor, the solubility limit of its protonated form in the solution, and the pKₐ of the inhibitor. If the pH of the sample is reduced to proximately above or below the pKₐ value, depending on the concentration (i.e., its solubility limit) of one group of target corrosion inhibitors, that group of target corrosion inhibitors begins to phase separate from the solution and are more susceptible to solid phase adsorption from the solution. For each specific target corrosion inhibitor, as the total inhibitor concentration is lowered, phase separation is observed to occur at lower pH values. If the intent is to remove all of the corrosion inhibitors from a typical fluid sample, the pH is reduced to well below the lowest pKₐ value of the group of targeted corrosion inhibitors. In the case where the total inhibitor concentration does not exceed the solubility limit of the acid form, phase separation of the inhibitor may not occur.

For all inhibitor organic acids, as the pH of the solution is lowered by one, two, or even three pH units below the pKₐ value of the component of interest, the efficiency of separation is further improved because more of the carboxylate salt is driven by acid-base equilibrium into the carboxylic acid form. This lowering of the pH enables more efficient phase separation as well as more efficient hydrophobic solid phase adsorption for the fraction of acid that is still soluble (due to that fraction's intrinsic solubility). When the total concentration of that specific inhibitor drops below the solubility limit for the acid form, removal of that component must be performed entirely through methods such as chemical adsorption from solution via hydrophobic interaction with the solid phase adsorbent. The relative proportion of acid undergoing separation from the solution via phase separation versus that being separated by solid phase adsorption depends therefore, upon the total concentration of the specific inhibitor and the solubility limit for the acid form of the specific inhibitor under consideration.

As used herein, the reference to a target corrosion inhibitor being “rendered at least partially insoluble” means the pH of the sample fluid has been adjusted to a level at which the concentration of target corrosion inhibitor has reached its solubility limit. As indicated above, this pH level may be reached before or after passing the pKₐ value of the target compound depending, at least partly, on the initial concentration of the target compound in the sample fluid. Similarly, the fluid sample may be referred to as being acidified to “render target acid-based corrosion inhibitors at least partially insoluble therein.” As used herein, this means that the pH of the sample fluid has been adjusted to a level at which at least one of the groups of target corrosion inhibitors has reached its solubility limit.

Next, the target acid-based corrosion inhibitors are separated from the sample (step 14). In a preferred method, the separated portion or residue contain target organic acid-based corrosion inhibitors and exclude corrosive short-chain organic acids and other analytical interferents, which would otherwise affect some measurement methods (e.g., titration). These excluded interferents include organic acids that are glycol oxidation products (e.g., glycolic acid or formic acid, and inorganic acid components such as silicates, borates, phosphates, nitrites and nitrates). For example, the acidified sample may be passed through an extraction device so that the target organic acid-based corrosion inhibitors are left as residue.

The extraction device may be in the form of a membrane, a filter bag, a solid phase extraction apparatus and the like. An analytical solid phase extraction (SPE) cartridge is one suitable extraction device. These SPE cartridges are pre-packaged solid sorbents that are used to isolate and/or concentrate analytes prior to employing chromatographic or other analytical methods to quantify the amount of analyte in a sample. A wide range of sorbents of varying particle size and chemistries are available and usually include chemically modified silicas, aluminas and modified polymers that have been tailored for specific chemical applications. Examples of various suitable and preferred SPE cartridges are provided later in this Detailed Description. The present invention is not intended to be limited, however, to any specific type of extraction device or SPE cartridge.

In a method employing an SPE cartridge, the sample is loaded into the SPE cartridge and the acidifying solution and other highly water-soluble analytical interferents are washed from the cartridge and thereby, separated from the acid-based corrosion inhibitors of interest. Thereafter, the separated residue containing the target acid-based corrosion inhibitors is measured or otherwise evaluated (step 16) using one of a number of commonly known analytical methods. These methods may be employed to quantify or qualitatively analyze the residue. Suitable measurement methods may involve a titration process and/or chemical reactions.

In one employment of the method, wherein an SPE cartridge is used, the acid-based corrosion inhibitors are eluted from the solid phase extraction cartridge. A suitable solvent, such as methanol or isopropanol, may be used for this purpose. The acid-based corrosion inhibitors are then collected from the SPE cartridge and quantified by a titration process. Alternatively, the collected corrosion inhibitors of interest may be analyzed by way of a quantitative reaction using a standardized base solution with an acid-base color indicator. The occurrence of the reaction and indication of a color change indicates that the concentration of acid-based corrosion inhibitors in the sample is equal to, above, or below a predetermined level.

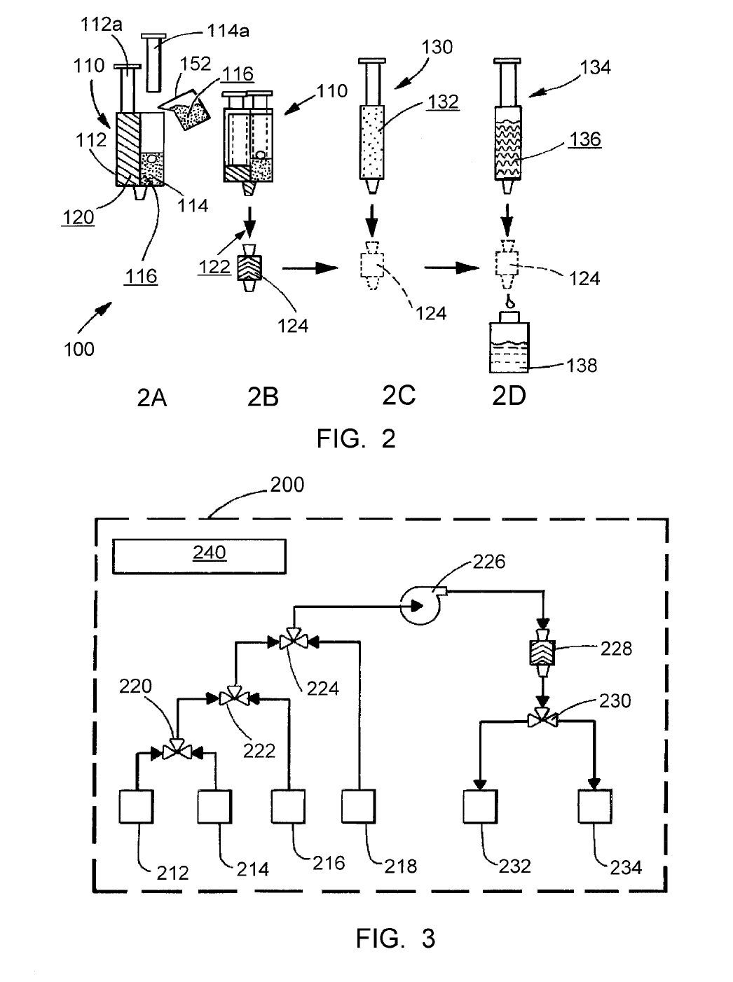

As mentioned above, a system and/or apparatus for employing the method described above may be a manual, an automated, or a semi-automated system or apparatus. FIG. 2 illustrates operation of a manual system that is particularly suited for use as a field-ready kit. Such a “field kit” may include all the components and prepared solutions necessary for performing the general evaluation method described above. In a method using one field kit, a simple calorimetric analysis is performed to determine whether the concentration of target corrosion inhibitors in the heat exchange fluid is below or above a predetermined level.

FIG. 2 depicts various components of an exemplary system 100 for evaluating the concentration of acid-based corrosion inhibitors contained in a heat exchange fluid. The system 100 includes a dual-barrel syringe 110 having a first barrel 112 and a second barrel 114, and corresponding plungers 112a and 114a. The dual-barrel syringe 110 is used to measure an accurate volume of sample fluid 116 and then to mix the sample fluid 116 with a predetermined volume of an acidifying solution 120, such as an acid but, more preferably, an acid buffer 120. The sample fluid 116 may be poured from a small container vial, tube, or beaker 152. The first barrel 112 contains a predetermined volume of the acidifying solution 120 while the second barrel 114 contains a predetermined volume of the sample fluid 116. Preferably, the second barrel 114 is provided with a level indicator to ensure that an exact volume of sample fluid 116 is mixed with the acidifying solution 120.

As illustrated in FIG. 2A, the first barrel 112 may be preloaded with a volume of acid or buffer that will reduce the pH of the mixture with sample fluid 116 in barrel 114 below a predetermined level. In the case of acid-based corrosion inhibitors, the pH of the resultant acidified sample 122 (as shown in FIG. 2B) is adjusted preferably to a pH below about 6 and, more preferably, to within the range of about 2 to about 4. In this way, the target corrosion inhibitor organic acids in the sample fluid 116 are rendered insoluble, or substantially insoluble, in the acidified sample 122.

Acid buffers suitable for use with the invention (as the acidifying solution) are generally known. Typically, acid buffers are a mixture of an acid and its salt. Examples of suitable acid buffer systems include HCl/KCl systems (pH=1-2), sodium dihydrogen phosphate/phosphoric acid systems (pH=2-4), potassium tetraoxalate systems (pH=1-2), acetic acid/sodium acetate (pH=3-6), HCl/citric acid systems (pH=1-5). A suitable acid buffer system will have a reactive acid capacity to react with the basic buffers of the ELC coolant systems and neutralize these basic buffers while controlling the pH of the final mixture. The corrosive nature of the acid reagent is thus minimized.

In general, any readily available acid capable of reducing the pH of the sample fluid in the preloading step as desired may be used as the acidifying solution instead of an acid buffer. Acids such as hydrochloric acid, sulfuric acid, nitric acid, or phosphoric acid (i.e. 0.1 molar to 1 molar in concentration) may be used. These concentrated acids will also neutralize the basic ELC coolant media and reduce the pH for the intended purpose. The use of these acids will require, however, that operating procedures are specifically implemented, and operating equipment designed, for the handling of corrosive materials.

Moreover, the dual barrel system 110 depicted in FIG. 2A is designed to enable coolant and acidifying solution to premix just prior to, or during, manual injection of the acidified sample 122 into an SPE cartridge 124 (as shown in FIG. 2B). The acidified sample 122 is injected into the SPE cartridge 124 at a rate that is sufficiently slow to allow adsorption of target organic acids from the acidified sample 122 onto the SPE cartridge 124. In this process, most of the heat exchange fluid and water-soluble components of the fluid (including corrosive short-chain organic acids and inorganic acids) are expended from the SPE cartridge 124 as wash.

Referring to FIG. 2C, a second syringe 130 is provided in the kit to contain a predetermined volume of water 132 that has been acidified to a desired pH. For example, the pH of the water 132 may be in the range of about 3 to 4. A suitable presolution is selected having a pH that is not too low to cause error in a subsequent analytical procedure but not too high as to cause the corrosion inhibitor organic acids to re-dissolve. The water solution 132 may be prepared by diluting a strong acid, such as hydrochloric acid, to a low concentration in distilled water. Preferably, the concentration range will be about 0.001 to about 0.0001 molar. The resulting solution 132 is used to rinse the SPE cartridge 124 and wash away water-soluble acids, salts, and buffer components that remain on the cartridge 124. During this washing step, the pH is maintained low enough to ensure continued binding of the acid-based corrosion inhibitors on the SPE cartridge 124.

Now referring to FIG. 2D, the system 100 may further include a third syringe 134 to hold and dispense an organic solvent 136. In principal, any organic solvents or organic solvent mixtures that can desorb and dissolve the organic acid ELC compound from the SPE media may be used. Suitable organic solvents include alcohols such as methanol, ethanol, and isopropanol. Other polar organic solvents such as acetone and tetrahydrofuran are also suitable provided these are applied in an appropriate manner.

The organic solvent 136 is used to elute the target organic acids (i.e., corrosion inhibitors of interest) from the SPE cartridge 124. This organic eluent may be directed to and collected in a vial 138 or other container. In one rendering of the method, the vial 138 holds a prepared solution of a fixed dose of a base (e.g., 0.1 molar sodium hydroxide in water) (a “standardized base solution”) and a suitable acid-base color indicator. The prepared vial 138 collects the SPE eluent as the contents of the syringe 134 are flushed through the SPE cartridge 124. The vial 138 is preferably capped and then, shaken to mix the organic solvent solution and the standardized base solution. This ensures a quantitative reaction between the eluted organic acids in organic solvent and the base. A color change indicates that the concentration of acid inhibitors in the eluent is in excess or equal to a predetermined threshold concentration. This predetermined threshold amount corresponds, of course, to the desired threshold or minimum concentration of acid inhibitors in the heat exchange fluid in use. It should be noted that any appropriate indicator may be used for indicating or detecting the threshold concentration of acid inhibitors.

Acid-base color indicators are typically dyes. The dyes are weak acids or bases that react and change color in response to the presence of excess acid or base. The various types of acid-base color indicators and their use are generally known. An acid-base color indicator is preferably selected such that it changes color during the sharp end point of the titration curve of the target organic acid against the base. When a reaction with a strong base (e.g., sodium hydroxide) is used to quantify target organic acid-based corrosion inhibitors in aqueous systems, acid-base color indicators suitable for evaluating the results are those having a pKₐ of about 2 to 4 pH units above that of the ELC organic acids (i.e. pKₐ of about 5). Thus, indicators changing color in the pH range of 7 to 10 are suitable for estimating the end point for these reactions. Examples of acid-base indicators suitable for this application include such dyes as bromthymol blue, phenol red, neutral red, cresol red, thymol blue, alpha-naphthophthalein, thymol blue, and phenolphthalein.

The preferred method described above is particularly advantageous over prior art methods of testing extended life coolant/heat exchange fluids to determine the content of acid-based corrosion inhibitors. In the above-described method, the long-chain alkyl and the aromatic organic acids, such as the carboxylic acid-based corrosion inhibitors, are excluded from the rest of the sample, and particularly from corrosive short-chain organic acids and other acidic interferents. In this way, after separation, measurement of organic acids by conventional methods such as titration, will only detect the targeted organic acids (i.e., the target corrosion inhibitors). The measurement will not be affected or interfered by inclusion of short-chain organic acids and other acidic interferents, including inorganic acids.

It is not uncommon for consumers to mix extended life coolants with other heat exchange fluids. A common mixture may include short-chain organic acids and inorganic acid-based corrosion inhibitors along with long-chain organic acid-based corrosion inhibitors. Hybrid extended-life coolants also contain a mixture of inorganic and long-chain organic acid-based corrosion inhibitors. In one preferred method, only the corrosion inhibitors that render the heat exchange fluid to be “extended life” are detected. Accordingly, in a quantitative measurement, the amount of “extended life” additives or coolant required to replenish the mixture and preserve its extended life can be determined.

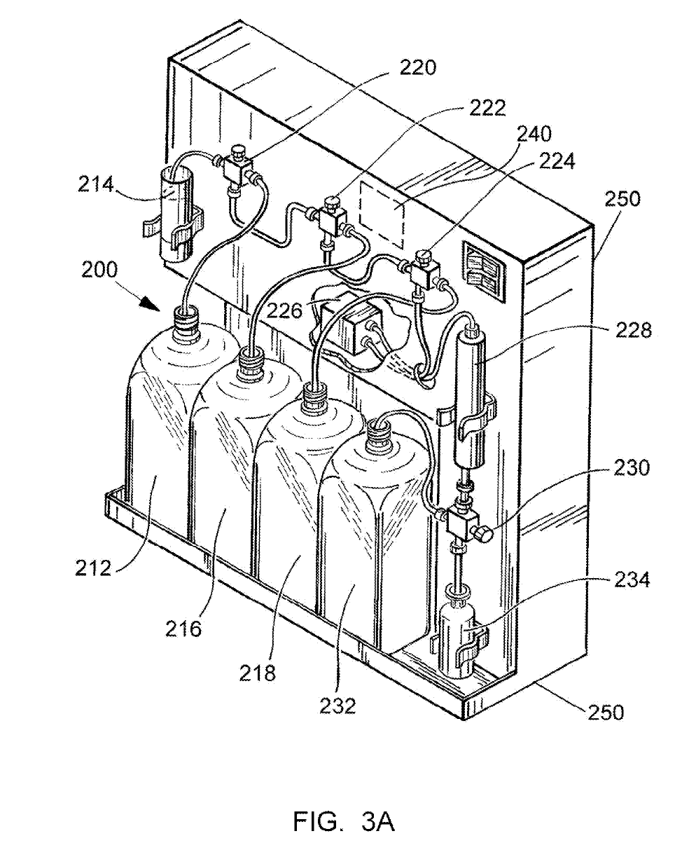

FIG. 3 is a schematic of an automated apparatus or system 200 for evaluating a heat exchange fluid. The automated apparatus 200 utilizes a pumping system including a metering pump 226 and interconnected piping operable to draw from, or dispense to, a bank of several containers. These containers include an acidifying solution container 212 which, in this example, contains an acid buffer, a heat exchange fluid sample container 214, a rinse solution container 216, and an organic solvent wash container 218, which, in this example, contains isopropyl alcohol. The automated system 200 further includes a three-way valve 220 that is positioned for selective communication with the acidifying solution container 212 and sample container 214. A second three-way valve 222 is positioned for selective communication with the outlet of three-way valve 220 (and thus, the buffer container 212 and sample container 214), as well as the rinse solution container 216. Furthermore, a third three way valve 224 is positioned for selective communication with the outlet of three-way valve 222 (and thus, three way valve 220, buffer container 212, sample container 214, and rinse solution container 216), as well as the wash container 218.

The automated system 200 is further provided with a metering pump 226 that, as illustrated in the schematic of FIG. 3, is operable (by way of valves 220, 222, and 224) to selectively draw from each of containers 212, 214, 216, 218. The metering pump 226 may be any one of a number of pumps suitable for continuous duty and precise delivery demands. Suitable pump types include a peristaltic, modified solenoid, diaphragm, gear, syringe, or any other positive displacement type pumps. In one or more preferred systems, a peristaltic pump with or without a position index indicator and solenoid type metering pumps are preferred.

It will be apparent to one skilled in the instrumentation, chemical or other relevant art, that the three way valves may be provided by solenoid valves, mechanical ball valves, and pinch valves. The three way valves may also be replaced with combinations of on/off valves.

The automated system 200 further includes an SPE cartridge 228 as previously described. As shown in FIG. 3, the SPE cartridge 228 is positioned on a discharge side of metering pump 226, and three-way valve 230 is positioned on a discharge side of SPE cartridge 228. The three-way valve 230 may be selectively operated to discharge into a waste container 232 or an analyte container 234. As necessary, an embedded programmable logic controller (PLC) or a microchip 240 is incorporated to interface with and program the operation of the metering pumps and three way valves.

At startup, the metering pump 226 alternatively draws buffer and sample by switching three-way valve 220 and drawing alternately from acidifying container 212 and sample container 214. The required mixing between the buffer and sample is affected in this way prior to introduction into the SPE cartridge 228. For example, about 5 milliliters of the sample and 10 milliliters of the buffer may be metered into SPE cartridge 228 by controlling the timing of the metering pump 226 and the position of the valve 220. The piping between the valve 220, the metering pump 226, and the SPE cartridge 228 provide further mixing of the buffer and sample.

FIG. 3A is a front view of a physical embodiment of the schematic of the automated system 200. The system or apparatus 200 is a stand-alone unit that is particularly suited for use in a garage, automotive shop, and other facilities for servicing vehicles. The apparatus 200 includes a frame 250 onto which the components of the system 200 are mounted. As shown in FIG. 3A, the system 200′ utilizes a bank of containers mounted on the frame 250. The containers include buffer container 212, rinse container 216, organic solvent wash container 218, and waste container 232. Furthermore, the system 200′ includes a sample container 214 secured to the frame 250 by way of clamps or other support, as well as a glass vial or equivalent container 234 for receiving the analyte (i.e., SPE eluent). Specifically, the analyte container 234 is positioned on a discharge side of the SPE cartridge 228 that is mounted on the frame 250 thereabove. The containers 212, 214, 216, 218, 232 and three way valves 220, 222, 224 are interconnected with metering pump 226 and SPE cartridge 228 by a system of tubing. In FIG. 3A, the pump 226 is mounted on an inside or hidden portion of the frame 250. The PLC or microchip 240 may also be mounted on the inside of the frame 250 and operable therefrom, to initiate and control communication and interaction between the above-mentioned components.

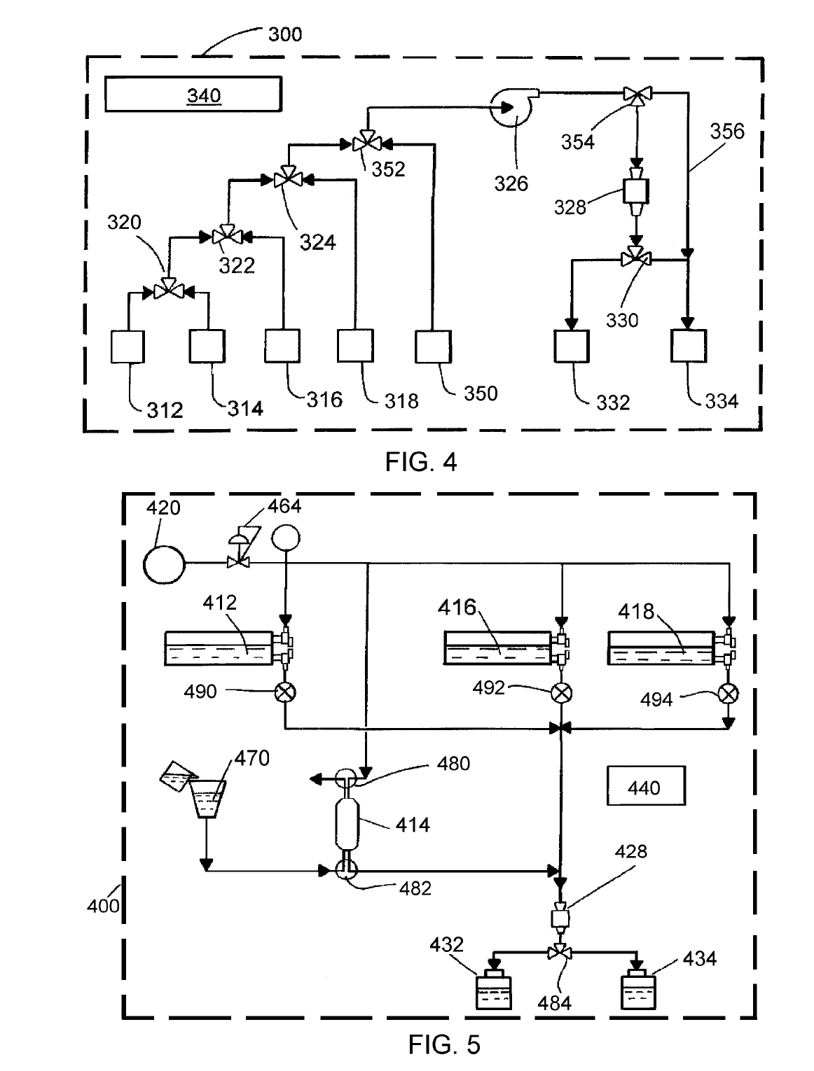

FIG. 4 depicts a schematic of an alternative system or apparatus for evaluating a heat exchange fluid as previously described. In this alternative apparatus, an additional container 350 is provided for holding a ready supply of a prepared solution of a caustic and a pH indicator (e.g., acid-base color change indicators as described previously). The container 350 is fluidly connected with metering pump 326 via a fourth three way valve 352 and piping therebetween. Moreover, a three-way activating valve 354 is provided between the SPE cartridge 328 and metering pump 326, while bypass line 356 is provided between the three way valve 354 and the analyte container 334. As illustrated in FIG. 4, the three-way valve 354 may be operated to direct a discharge of metering pump 326 into SPE cartridge 328 or directly to the analyte container 334. Thus, in operation, caustic along with the pH indicator can be added by operating the metering pump 326 to draw from container 350, through valve 354, and directly into the analyte container 334 (e.g., reaction vial 334). In this way, the caustic and the pH indicator are added and metered instead of being preloaded into the analyte container 334. Use of the metering pump 326 to draw the caustic and pH indicator also provides a desirable degree of precision and control.

In a further extension of the apparatus illustrated by FIGS. 3 and 4, an automatic titrator is incorporated into the apparatus. Use of such a titrator, allows for quantitative determination of the exact levels of acid-based corrosion inhibitors left in the heat exchange fluid sample. An exact determination of the corrosion inhibitor concentration, e.g., by way of the titration method, would therefore supplant use of the color indicator pass/fail method described above. A suitable apparatus will include equipment for quantification of the acid inhibitor content by an acid-base titration process. In this particular case, caustic reagent would not be pre-loaded into the analyte container (234, 334 or 434) but would, instead, be quantitatively added as a titrant after sample elution from the SPE cartridge. Elution may be performed using a solvent such as methanol or isopropyl alcohol. Additional equipment required for such a titration apparatus would include an additional pump to allow caustic titrant to be dosed continuously, or intermittently, as a function of time so that the exact volume of caustic titrant added is known. The pump 226 or 326 may be modified for this purpose. Secondly, a measuring probe may be included for determining the end point of titration. This probe may be a calorimeter operable to determine the change in color of the acid-base indicator. Alternatively, the end point probe may be a pH probe operable to determine the end point of the titration by direct pH measurement. Thirdly, the apparatus may include an expanded microchip, or programmable logic controller (PLC) for computing the results of the quantitative titration.

FIG. 5 depicts yet another alternative system or apparatus for employing the evaluating method previously described. The apparatus 400 utilizes a pneumatic system including a pressure source 420 as a pumping system to selectively draw from a bank of containers. The pressure source 420 may be pressurized air that is reduced down to a lower and constant pressure of about 1 to 5 psig through use of a standard pressure regulator 464. The apparatus further includes a sample holder/container 414, an acidifying solution container 412, a rinse acid container 416, and elution solvent container 418. Moreover, the apparatus 400 may include a waste container 432 and an analyte container 434, such as a vial of a measured dosage of caustic and pH indicator (e.g., acid-base color indicator).

As illustrated in FIG. 5, the larger containers 412, 416, and 418 preferably have a low profile. In this way, the flow rates from the containers are not significantly affected by the changes in the liquid level inside the containers. Alternatively, high air pressure (e.g., up to 10 to 20 psig) may be used with restrictors at each outlet of the containers. Furthermore, all of the containers may be equipped with faucets or spigots to allow for isolation of each container and to facilitate container exchange.

In an exemplary operation of the apparatus 400, the heat exchange fluid sample is fed to the system 400 via a funnel 470 and into sample holder 414. Sample holder 414 has a fixed volume, e.g. 5 milliliters, and is equipped with a top three-way valve 480 and bottom three-way valve 482. During sample loading, top valve 480 is open to outlet so that any excess sample is overflowed to waste. Furthermore, by feeding the sample through the bottom of the holder 414, entrained air bubbles or vapors are eliminated from the sample, thereby facilitating metering. Selective positioning of valves 490, 480 and 482 allow for mixing of acid buffer from container 412 with the sample in sample holder 414 and the delivery of the mixture to SPE cartridge 428.

Additionally, valves 492 and 494 are positioned on discharge sides of containers 416, and 418, respectively. Operation of these valves in conjunction with the other valves in the system 400 and a programmable logical controller 440 (PLC) selectively delivers fluid through the SPE cartridge 428.

In one alternate step of the method, the amount of acid may be measured quantitatively. For example, a calorimeter may be used to automatically determine the color change of the titrated solution. In this setup, the system may be run to determine the amount of base needed for the color change. Such measurement may provide the concentration of the organic acid inhibitors in the heat exchange fluid. With this determination, the useful life of the heat exchange fluid may be estimated. Moreover, this information may be used to refortify the heat exchange fluid so as to extend the useful life.

Accordingly, the method, system, and apparatus described above provide a reliable, field ready and convenient method for analyzing the heat exchange fluids. The system and apparatus described above are particularly useful for original equipment manufacturers (OEMs), fleet owners, and automotive shops (e.g., truck stops or fast lube facilities). One benefit of the described method, systems, and apparatus, is that it provides a quick, efficient, and accurate quantitative field method for determining the residual content of target acid-based corrosion inhibitors in either fresh, contaminated, or used extended life heat exchange fluids. Accordingly, the method may be used to actually determine the concentration of acid-based corrosion inhibitors in order to determine the heat exchange fluid's utility for continued use and alternatively, to determine how much of any fresh corrosion inhibitors may be added to maintain the heat exchange fluid's utility.

Exemplary Experiments Illustrating the Present Method of Evaluating the Constituents of Heat Exchange Fluid

### EXAMPLE 1

In this experiment, unused commercially available Rotella ELC coolant formulation was diluted two-fold to a concentration typical for commercial coolant application. The sample was spiked with low molecular weight acid contaminants, or their salts (i.e., potassium acetate, sodium oxalate, sodium formate, and glycolic acid), in order to demonstrate the separability of these typical coolant contaminants from the ELC inhibitors of analytical interest under the typical SPE separation conditions used for analysis. The SPE cartridge used for this test was a commercially available Varian Bond Elute C-18 cartridge (1 gram/6 cc, octadecylsilane derivatized silica). The SPE was pretreated with 15 ml of methanol followed by 15 ml of 0.1 molar phosphate buffer (i.e., adjusted to pH 2.2 with phosphoric acid) prior to use.

The sample was prepared by mixing 1.00 ml of the heat exchange fluid (Rotella Blend 24920-58-3, i.e., see the composition information below) to 4.00 ml of the 0.1M potassium dihydrogen phosphate buffer (pH 2.2). The 5 ml of acidified sample was added to the SPE and the eluent collected as Fraction 1. This was followed by two 5 ml fractions eluting with 0.1 M phosphate buffer at pH 3.0 (i.e., Fractions 2 and 3). Subsequently, these were followed with three 5 ml elutions using methanol, which were collected as Fractions 4, 5, and 6. All six fractions were diluted to exactly 10.0 ml with methanol in volumetric flasks and were analyzed by HPLC to determine the order of elution for the acids known to be present.

The six fractions collected were identified as follows:

Fraction 1: 1.00 ml Sample+4.00 ml pH 2.2 phosphate buffer,

Fraction 2: 5.00 ml of pH 3.0 phosphate buffer,

Fraction 3: 5.00 ml of pH 3.0 phosphate buffer,

Fraction 4: 5.00 ml methanol,

Fraction 5: 5.00 ml methanol, and

Fraction 6: 5.00 ml methanol

The composition in weight percent of the diluted test heat exchange fluid sample of Rotella Blend 24920-58-3 was the following in acid components and inhibitors of interest:

| | |
|---|---|
| 2-EHA (inhibitor) | 1.69% |
| Sebacic acid (inhibitor) | 0.131% |
| Tolytriazole (inhibitor) | 0.120% |
| Potassium acetate | 0.314% |
| Sodium oxalate | 0.280% |
| Sodium formate | 0.281% |
| Glycolic acid | 0.378% |

The data for the components of interest in the six fractions collected were as follows:

TABLE 1a
Recovery of acids and corrosion inhibitor components
with elution from a C-18 SPE Cartridge

| | % Recovery | | | | | |
|---|---|---|---|---|---|---|
| | Fraction 1 | Fraction 2 | Fraction 3 | Fraction 4 | Fraction 5 | Fraction 6 |
| | pH 2.2 | PH 3 | pH 3 | methanol | methanol | methanol |
| Acetic acid | 55 | 40 | ND* | ND | ND | ND |
| Oxalic acid | 70 | 30 | ND | ND | ND | ND |
| glycolic acid | 69 | 29 | ND | ND | ND | ND |
| Formic acid | 60 | 28 | ND | ND | ND | ND |
| 2-ethyl hexanoic | ND | ND | ND | 102 | ND | ND |
| acid (2-EHA) | | | | | | |
| Sebacic Acid | ND | ND | ND | 101 | ND | ND |
| Tolytriazole | ND | ND | ND | 101 | ND | ND |

*ND—not detected

As indicated in Table 1a, low molecular weight acidic contaminants were principally eluted in aqueous Fractions 1 and 2, while the corrosion inhibitor components of interest were eluted quantitatively in the first methanol fraction, Fraction 4.

Other SPE devices found to work in a similar manner were the following:
Chrom-P (SDVB)—Sigma-Aldrich Corporation, Supelco, Supelclean-ENVI Chrom-P SPE, styrene divinylbenzene polymeric phase (SDVB), 0.5 gram, 6 ml cartridges,
Supelclean LC-18—Sigma-Aldrich Corporation, Supelco, Supelclean LC-18, octadecyl derivitized silica, C-18, 1 gram, 6 ml cartridges,
Bond Elute C-8—Varian Inc., Bond Elute C8, octyl derivatized silica, C8, 1 gram, 6 ml cartridges,
Bond Elute C-2—Varian Inc., Bond Elute C2, ethyl derivatized silica, C2, 1 gram, 6 ml cartridges.

### EXAMPLE 2

In this example, the separation of acid-based corrosion inhibitors from a Rotella extended life coolant blend was tested with the application of SPE cartridges that do not require pre-treatment. The acid treated sample was applied to a dry SPE cartridge. Also, in a washing step, 0.001 molar HCl solution was used to rinse the SPE prior to elution with alcoholic solvent, methanol or isopropyl alcohol. SPEs tested with the procedure included MN Chromabond Easy (1 gr/15 cc) and Waters Oasis HLB (60 mg/3 cc). The following fractions were added to the Chromabond Easy cartridge and the eluents collected for analysis:

| | |
|---|---|
| Sample addition | 3.00 ml Rotella Blend sample + |
| | 12.0 ml of pH 2.2 phosphate buffer |
| Fraction 1 | 5.00 ml of pH 2.2 buffer rinse |
| Fraction 2 | 5.00 ml of pH 2.2 buffer rinse |
| Fraction 3 | 5.00 ml of 0.001 molar HCl rinse |
| Fraction 4 | 5.00 ml methanol or isopropyl alcohol |
| Fraction 5 | 5.00 ml methanol or isopropyl alcohol |
| Fraction 6 | 5.00 ml methanol or isopropyl alcohol |

Because the Water Oasis HLB cartridge was much smaller, only 0.5 ml of sample was mixed with 2.5 ml of pH 2.2 phosphate buffer and applied. All fractions for this cartridge were 3.00 milliliters in volume rather than the 5.00 ml noted above.

The Rotella Blend 24920-53-2 used contained an unused Rotella ELC spiked with low molecular weight acid contaminants, or their salts, so as to demonstrate the separability of these typical coolant contaminants from the ELC inhibitors of analytical interest. The blend had the following composition for the components of interest:

| | |
|---|---|
| 2-EHA (inhibitor) | 1.70% |
| Sebacic acid (inhibitor) | 0.131% |
| Tolytriazole (inhibitor) | 0.121% |
| Potassium acetate | 0.158% |
| Sodium oxalate | 0.148% |
| Sodium formate | 0.100% |
| Glycolic acid | 0.196% |

Table 2 below shows the results of HPLC analyses of the collected fractions. The results indicate that there were no losses in recovery resulting from the use of cartridges with no pre-treatment. There were also no losses in recovery from the use of a rinse with 0.001M HCl to remove acidic buffer from the SPE prior to sample elution. The weak acid rinse was necessary to ensure that the acid buffer remaining on the SPE column after rinsing is negligible, or at least small and constant. This allows for a quantitative acid-base reaction or titration to be used, if desired, in the finishing step. Recoveries reported above 100% in Table 2 are the result of an HPLC measurement bias error and measurement uncertainty errors.

TABLE 2
Recovery of Corrosion Inhibitors from SPE cartridges with and
without SPE Pretreatment and all with a 0.001 M HCl rinse.
All data are recoveries found in the first IPA or first Methanol
elution fraction from the SPE (i.e. Fraction 4).

| | Recovery (%) | | |
|---|---|---|---|
| | with SPE pretreat | no SPE pretreat | no SPE pretreat |
| Chromabond Easy | Methanol | Methanol | IPA |
| 2-EHA | 106 | 108 | 108 |
| Sebacic | 109 | 106 | 103 |
| Tolytriazole | 102 | 101 | 95 |

| | no SPE pretreat | no SPE pretreat |
|---|---|---|
| Waters Oasis HLB | Methanol | IPA |
| 2-EHA | 107 | 105 |
| Sebacic | 94 | 121 |
| Tolytriazole | 105 | 103 |

### EXAMPLE 3

In this series of experiments, a four-step SPE procedure was employed utilizing a variety of 1.0 gram SPE sample preparation cartridges. The procedure was as follows:
1) Mix 5.00 ml of a heat exchange fluid sample with 10.00 ml 0.1M phosphate buffer adjusted to pH 2.2 with phosphoric acid.
2) Apply the 15 ml of acidified sample through the SPE cartridge.
3) Rinse the SPE cartridge with 15 ml 0.001 M HCl rinse solution.
4) Rinse the SPE with 15 ml isopropyl alcohol and collect the eluent for analysis.

The 15 ml eluent in step 4 was collected for HPLC analysis to determine coolant corrosion inhibitor recovery and in separate duplicate experiments, was collected for titration to determine total coolant inhibitor acid content. For each HPLC recovery experiment, an original 5.00 ml sample not processed by SPE was diluted to 50.0 ml in a volumetric flask in HPLC solvent, in order to serve as a measure of 100% recovery. The IPA eluents from the SPE cartridges intended for HPLC analysis were collected directly into 50.0 ml volumetric flasks and diluted with HPLC solvent to the 50.0 ml volume prior to HPLC analysis. The following SPE cartridges were tested:
1. Chromabond Easy—Macherey-Nagel Gmbh & Co., modified polystyrene-divinylbenzene solid phase, 1 gram, 15 ml SPE cartridge.
2. Isolute Env+—International Sorbent Technology LTD, Part 915-0100-E, 1 gram, 25 ml cartridge, a hydroxylated polystyrene-divinylbenzene copolymer,distributed in the United States of America by Biotage Discovery Chemistry Division, Charlottesville, Va. (formerly by Argonaut Technologies, Redwood City, Calif.).
   These cartridges were advertised not to require any solvent pre-treatment.

Two extended life coolant (ELC) samples were used for these experiments. One sample, 24920-87-3, was a composite sample of a variety of actual spent ELC samples collected over time during ELC field evaluation studies. The second sample was a fresh ELC sample, 24920-105-2, with the following composition in weight percent of acid-based corrosion inhibitors of interest:

| | |
|---|---|
| 2-EHA (inhibitor) | 1.71% |
| Sebacic acid (inhibitor) | 0.13% |
| Tolytriazole (inhibitor) | 0.12% |

The composition of the composite sample, 24920-87-3 in weight percent of acid components and corrosion inhibitors of interest was the following:

| | |
|---|---|
| 2-EHA (inhibitor) | 1.26% |
| Sebacic acid (inhibitor) | 0.1% |
| Tolytriazole (inhibitor) | 0.095% |
| Benzoic acid (inhibitor) | 0.05% |
| tert-Butyl benzoic acid (inhibitor) | 0.02% |
| para-toluic acid (inhibitor) | 0.01% |
| Acetic acid | 0.0093% |
| Oxalic acid | 0.0413% |
| Formic acid | 0.0090% |

The results from the HPLC recovery experiments are shown in Table 3A. The HPLC recoveries indicate consistent and near complete recovery within experimental error for the ELC corrosion inhibitor components found in the spent coolant composite as well as the components in the Rottela brand ELC blend.

TABLE 3A
HPLC Recovery Determinations from two ELC samples
for eluents from various SPE cartridges employing
the four step SPE sample preparation procedure

| | Spent Coolant Composite Sample (24920-87-3) | |
|---|---|---|
| | Chromabond Easy | Isolute Env+ |
| Corrosion Inhibitor | Cartridge Recovery (%) | Cartridge Recovery (%) |
| 2-EHA | 97 | 99 |
| Sebacic | 89 | 93 |
| Tolytriazole | 88 | 93 |
| Benzoic Acid | 92 | 101 |
| t-butylbenzoic acid | 86 | 92 |
| p-toluic acid | 90 | 96 |

Unused Rottela ELC Sample (24920-58-3)

| | Chromabond Easy | Isolute Env+ |
|---|---|---|
| Corrosion Inhibitor | Recovery (%) | Recovery (%) |
| 2-EHA | 97 | 99 |
| Sebacic | 87 | 97 |
| Tolytriazole | 89 | 97 |

In a separate set of experiments, the eluents recovered in steps 2, 3 and 4 using the Chromabond Easy SPE cartridge were analyzed by ion chromatography. The low-molecular weight organic acids (glycolic, formic and acetic acids) were detected only in the eluents from steps 2 and 3 whereas none of these acids were detected in the IPA eluent from step 4 thereby demonstrating their separation from the acid-based corrosion inhibitors.

The four-step process outlined in this example was also demonstrated to work with two other cartridges that are listed below:
1. Chrom-P (SDVB)—Sigma-Aldrich Corporation, Supelco, Supelclean-ENVI Chrom-P SPE, styrene divinylbenzene polymeric phase (SDVB), 0.5 gram, 6 ml cartridges,
2. abselut NEXUS, 500 mg, 20 ml cartridge, part #12253103, an SDVB/methacrylate copolymer sorbent for non-conditioned solid phase extraction, Varian, Inc., Palo Alto, Calif.
   Of the above, only the Chrom-P cartridge was pre-treated as described in Example 1. The abselut NEXUS cartridge was advertised not to require solvent pre-treatment. In this case only 3 ml of sample was used and the 15 ml eluent from step 4 was diluted to 25.0 ml in a volumetric flask in HPLC solvent.

In order to demonstrate that the total acid-based corrosion inhibitor amount can be quantified using titration, a separate set of experiments were conducted in which the isopropyl alcohol eluents from the SPE cartridges (from step 4 of the process outlined in this example) were titrated quantitatively with 0.099N sodium hydroxide solution. The results from the titration are presented in Table 3B below.

TABLE 3B
Titration results from the titration of Isopropyl
Alcohol eluents from the Four step SPE procedure

| | Spent Coolant Composite, 3.00 mls sample | |
|---|---|---|
| SPE Type | mls 0.09854 NaOH | Expected Value |
| Chromabond Easy | 3.3 | 3.5 |
| Isolute Env+ | 3.4 | |
| Isolute Env+ (repeat) | 3.3 | |

Unused Rottela, 3.00 ml sample

| SPE Type | mls 0.09854 N NaOH | Expected Value |
|---|---|---|
| Chromabond Easy | 4.4 | |
| Isolute Env+ | 4.6 | 4.5 |
| Chrom-P | 4.8 | |
| abselut Nexus | 4.5 | |

The expected values of the titrant were computed on the basis of the HPLC measured concentration of the acid-based corrosion inhibitors as listed in this Example. The titration results for the spent coolant were consistent and were within experimental error of the expected values (i.e. the combined errors of both HPLC measurement and titration).

The foregoing Description is presented for purposes of illustration and is not intended to limit the invention (as defined by the following claims) to the form described. Although several embodiments of the testing method, system and apparatus have been shown or described, alternative embodiments will be apparent to those skilled in the chemical, instrumentation, and other relevant art. For example, the various evaluation methods may be employed to evaluate other heat exchange fluid compositions not described herein. Moreover, the evaluation methods may be employed in conjunction with use of other testing components or arrangements. The embodiments described are further intended to explain the best mode of practicing the invention and to enable others skilled in the art to utilize the invention in such, or other, embodiments.

What is claimed is:

1. An apparatus for evaluating the constituency of a heat exchange fluid having acid-based corrosion inhibitors therein, said apparatus comprising:
a bank of solution containers including
a first container for receiving a sample of the heat exchange fluid and
a second container for holding an acidifying solution;
an extraction device for separating acid-based corrosion inhibitors from an acidified mixture of the heat exchange fluid and the acidifying solution; and
a pumping system fluidly interconnected with the bank of containers and the extraction device, the pumping system being operable to selectively draw amounts of the heat exchange fluid and an acidifying sample from the first and second containers, respectively, and to pass a resultant acidified mixture through the extraction device,
wherein target acid-based corrosion inhibitors are retained in the extraction device.

2. The apparatus of claim 1, wherein the first container contains a sample having organic acid-based corrosion inhibitors therein, and wherein the pumping system is operable to draw an acidified mixture of the sample and the acidifying solution when the organic acid-based corrosion inhibitors are at least partially insoluble.

3. The apparatus of claim 1, wherein the first container contains a sample having carboxylate salts of long-chain alkyl and aromatic organic acid-based corrosion inhibitors therein.

4. The apparatus of claim 1, wherein the extraction device is a solid phase extraction device configured to adsorb organic acid-based corrosion inhibitors from the acidified mixture passed therethrough.

5. The apparatus of claim 1, wherein the second container contains an acid buffer as the acidifying solution.

6. The apparatus of claim 5, wherein the bank of containers further includes a rinse solution container containing an acid solution, and wherein the pumping system is operable to pass acid solution from the rinse solution container through the extraction device so as to wash acid buffer therefrom.

7. The apparatus of claim 6, wherein the bank of containers further includes a solvent container containing a solvent sufficient to elute organic acids from the extraction device, and wherein the pumping system is operable to draw solvent from the solvent container and pass the solvent through the extraction device and elute adsorbed organic acids therefrom.

8. The apparatus of claim 7, further comprising an analyte container positionable to receive eluent from the extraction device.

9. The apparatus of claim 8, further comprising an indicator solution container containing a base solution and an acid-base color indicator, the indicator solution being fluidly interconnected with the pumping system such that the pump is operable to draw from the indicator container and provide a dosage in the analyte container.

10. The apparatus of claim 9, further comprising:
a third container for holding an acidic rinse solution for rinsing interferents; and
a fourth container for holding a rinsing solvent for eluting acid-based corrosion inhibitors of interest; and
wherein the pumping system fluidly interconnects the third and fourth containers therewith and is operable to draw amounts of acidic rinse solution and rinsing solvent from the third and fourth containers, respectively.

11. A method of evaluating the constituents of a heat exchange fluid having acid-based corrosion inhibitors therein, said method comprising the steps of:
obtaining a sample of the heat exchange fluid;
acidifying the sample to reduce the solubility of target acid-based corrosion inhibitors therein;
separating the target acid-based corrosion inhibitors from the acidified sample; and
evaluating the separated acid-based corrosion inhibitors, thereby obtaining an indication of the concentration of acid-based corrosion inhibitors in the subject heat exchange fluid.

12. The method of claim 11, wherein the target acid-based corrosion inhibitors include multiple groups of organic acid-based corrosion inhibitors, and wherein the sample is acidified such that at least one group of target organic acid-based corrosion inhibitors is rendered at least partially insoluble therein and then separated from the acidified sample during said separating step.

13. The method of claim 12, wherein the sample is acidified such that a plurality of groups of organic acid-based corrosion inhibitors are rendered at least partially insoluble therein.

14. The method of claim 12, wherein said acidifying step includes adjusting the pH of the sample to a first pH, thereby rendering a first group of target acid-based corrosion inhibitors at least partially insoluble in the sample and then further adjusting the pH to a second pH lower than the first pH, thereby rendering a second group of target acid-based corrosion inhibitors at least partially insoluble in the sample.

15. The method of claim 11, wherein the target acid-based corrosion inhibitors include carboxylate salts of organic acids.

16. The method of claim 11, wherein the target acid-based corrosion inhibitors include long-chain alkyl organic acid-based corrosion inhibitors, said acidifying step including adjusting the pH of the sample to render long chain alkyl organic acid-based corrosion inhibitors at least partially insoluble in the sample.

17. The method of claim 11, wherein the target acid-based corrosion inhibitors include aromatic organic acid-based corrosion inhibitors, said acidifying step including adjusting the pH of the sample to a pH that renders aromatic organic acid-based corrosion inhibitors at least partially insoluble therein.

18. The method of claim 11, wherein the acidified sample is passed through an extraction device to separate the target acid-based corrosion inhibitors.

19. The method of claim 11, wherein said evaluating step includes evaluating the separated acid-based corrosion inhibitors by performing a titration process.

20. A method of evaluating the constituents of a heat exchange fluid having acid- based corrosion inhibitors therein, said method comprising the steps of:
a) obtaining a sample of the heat exchange fluid;
b) separating target organic acid-based corrosion inhibitors from the sample; and
c) evaluating the separated organic acid-based corrosion inhibitors, thereby obtaining an indication of the concentration of organic acid-based corrosion inhibitors in the subject heat exchange fluid.
